(19) United States
(12) Patent Application Publication
(10) Pub. No.: US 2017/0068552 A1
(43) Pub. Date: Mar. 9, 2017

(54) INFORMATION PROCESSING DEVICE, METHOD, AND NON-TRANSITORY COMPUTER READABLE MEDIUM

(71) Applicant: KABUSHIKI KAISHA TOSHIBA, Tokyo (JP)

(72) Inventor: Makoto SATO, Tokyo (JP)

(73) Assignee: Kabushiki Kaisha Toshiba

(21) Appl. No.: 15/255,820

(22) Filed: Sep. 2, 2016

(30) Foreign Application Priority Data
Sep. 7, 2015 (JP) 2015-175664

(51) Int. Cl. G06F 9/445; G06F 9/44

(52) U.S. Cl. CPC G06F 9/44505; G06F 9/4421

(57) ABSTRACT

According to one embodiment, an information processing device including a hardware processor is provided. The hardware processor is configured to execute a switch module to determine whether a target node of nodes in a processing process is executable, the processing process being configured by the nodes and connections between the nodes, a plurality of processing modules being capable of being set in the nodes, based at least in part on input data of the processing module which is set in the target node; and execute the processing module which is set in the target node in response to the target node having been determined to be executable.

### CROSS-REFERENCE TO RELATED APPLICATIONS

This application is based upon and claims the benefit of priority from Japanese Patent Application No. 2015-175664, filed on Sep. 7, 2015; the entire contents of which are incorporated herein by reference.

### FIELD

Embodiments described herein relate to an information processing device, an information processing method, and a non-transitory computer readable medium.

### BACKGROUND

Various processing processes such as preprocessing of data, creation of a model, utilization of the model, and evaluation of the model need to be combined and carried out to conduct data analysis and operate decision-making support systems based on data analysis. Creation and management of processing processes for analysis of this kind are performed by a data engineer. In addition, information processing devices for assisting data engineers are commercially available.

Traditional information processing devices visualize the processing processes of data by a network structure constituted by nodes and arcs. A data engineer may use graphical user interfaces to specify processing modules in the nodes and change parameters. The costs associated with creation and management of the processing processes can be reduced by using such an information processing device.

Since detailed features of processing processes are networked in traditional information processing devices, processing processes having a network structure configured by the information processing devices tend to depend on their target projects and have low reusability. For this reason, a data engineer has to create processing processes on a per-project basis. This leads to increased workload of the data engineer.

In view of the above-identified problem, information processing devices are advocated that assign evaluation values to intermediate generated data and thereby makes the intermediate generated data reusable. In these information processing devices, as intermediate generated data is used, there is no need of reconfiguring the processing processes upstream with respect to the processing module that generates the intermediate generated data. As a consequence, workload of the data engineer can be reduced.

However, in the above information processing devices, processing processes are reusable between processing processes that shares the same intermediate generated data, but it is difficult to reuse the processing processes between processing processes that handle different data.

### BRIEF DESCRIPTION OF THE DRAWINGS

FIG. 1 is a diagram illustrating an example of a processing process configured by an information processing device in accordance with one embodiment;

FIG. 2 is a diagram illustrating an example of a functional configuration of the information processing device in accordance with the embodiment;

FIG. 3 is a diagram illustrating an example of module data;

FIG. 4 is a diagram illustrating an example of process data;

FIG. 5 is a diagram illustrating an example of execution type in the process data;

FIG. 6 is a diagram illustrating an example of parameter data;

FIG. 7 is a diagram illustrating an example of a hardware configuration of the information processing device in accordance with the embodiment;

FIG. 8 is a flowchart illustrating an example of operation of the information processing device in accordance with the embodiment;

FIG. 9 is a diagram illustrating an example of a processing module of a node 1;

FIG. 10 is a diagram illustrating an example of a processing module of a node 2;

FIG. 11 is a diagram illustrating an example of a processing module of a node 3;

FIG. 12 is a diagram illustrating an example of switch module;

FIG. 13 is a diagram illustrating an example of operation of the information processing device in accordance with the embodiment;

FIG. 14 is a diagram illustrating an example of operation of the information processing device in accordance with the embodiment;

FIG. 15 is a diagram illustrating an example of operation of the information processing device in accordance with the embodiment;

FIG. 16 is a diagram illustrating an example of parameter data of a processing module M1; and

FIG. 17 is a diagram illustrating an example of a processing module M1 adapted for the parameter data of FIG. 16.

### DETAILED DESCRIPTION

According to one embodiment, an information processing device including a hardware processor is provided. The hardware processor is configured to execute a switch module to determine whether a target node of nodes in a processing process is executable, the processing process being configured by the nodes and connections between the nodes, a plurality of processing modules being capable of being set in the nodes, based at least in part on input data of the processing module which is set in the target node; and execute the processing module which is set in the target node in response to the target node having been determined to be executable. Below, an embodiment of the present invention is described with reference to the accompanying drawings.

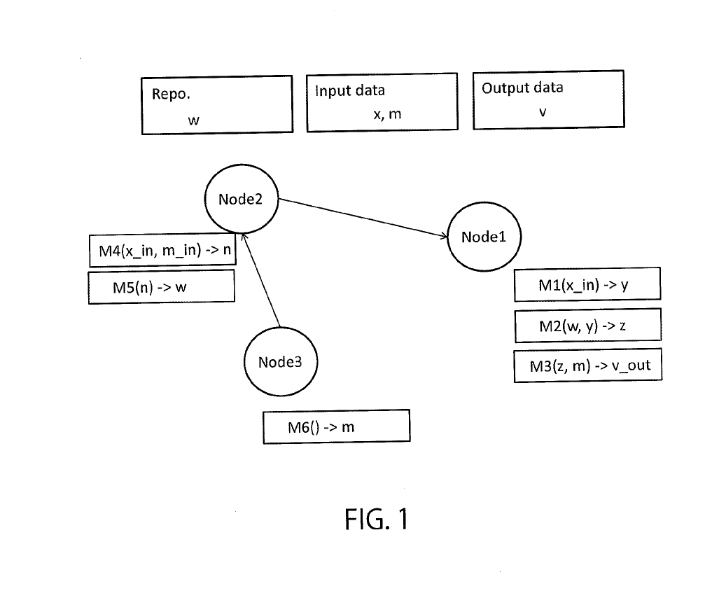

First, the outline of an information processing device according to one embodiment is described with reference to FIG. 1. The information processing device in accordance with this embodiment configures a visualized processing process of data. FIG. 1 is a diagram that illustrates an example of the processing process configured by the information processing device. As illustrated in FIG. 1, the processing process has a network structure that includes arcs and nodes (digraph structure).

One or a plurality of processing modules are set in each node. The “processing modules” as used herein refer to individual programs constituting the processing process. Also, a direction is given to each arc. FIG. 1 is a diagram that illustrates an example of the processing process configured by the information processing device.

The processing process of FIG. 1 includes three nodes (Nodes) 1 to 3, an arc interconnecting the nodes 1 and 2, and an arc interconnecting the nodes 2 and 3. Processing modules M1 to M3 are set in the node 1. Processing modules M4 and M5 are set in the node 2. A processing module M6 is set in the node 3. Also, the arrows of the arcs of FIG. 1 indicate the directions given to the arcs. The origin of the shaft of the arrow is the start point of the arc, and the tip of the arrowhead is the end point of the arc.

In the following, with reference to a certain node X, a node Y that corresponds to the start point of the arc whose endpoint is connected to the node X is referred to as “upstream node” with respect to the node X. Likewise, with reference to a certain node X, a node Y that corresponds to the end point of the arc whose start point is connected to the node X is referred to as “downstream node” with respect to the node X. For example, the node 3 is an upstream node with respect to the node 2. And the node 1 is a downstream node with respect to the node 2.

In the processing process configured by the information processing device, the processing proceeds from an upstream node to a downstream node. For example, in the processing process of FIG. 1, the processing is executed in the nodes 3, 2, 1 in this order. Execution of a node X as used herein refers to executing a processing module or modules set in the node X. For example, executing the node 1 refers to executing the processing modules M1 to M3 set in the node 1.

In the following, all the nodes for which the processing is executed before the processing for a certain node X is executed are referred to as “upstream-side nodes.” Likewise, all the nodes for which the processing is executed after the processing for a certain node X is executed are referred to as “downstream-side nodes.” For example, the node 2 and the node 3 are upstream-side nodes with respect to the node 1. The node 1 and the node 2 are downstream-side nodes with respect to the node 3.

A user such as a data engineer who uses the information processing device in accordance with this embodiment can configure processing process as illustrated in FIG. 1 and execute the configured processing process.

It should be noted that “Repo.” in FIG. 1 indicates a repository of the information processing device. “Input data” indicates a storage in which the information processing device can import an object. “Output data” indicates a storage to which the information processing device can export an object. In the example of FIG. 1, an object “w” is stored in the repository. Objects “x” and “m” are stored in the “Input data” storage. An object “v” is stored in the “Output data” storage.

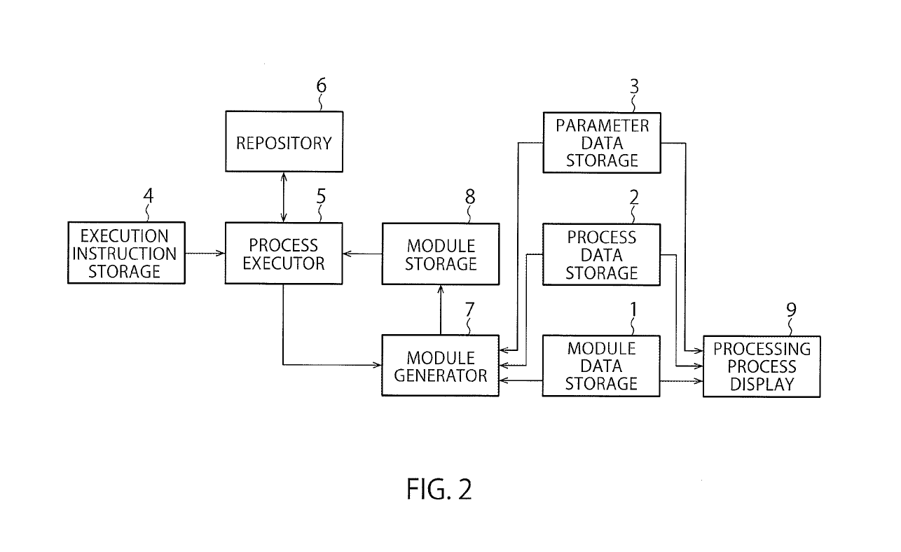

Next, the functional configuration of the information processing device in accordance with this embodiment is described with reference to FIGS. 2 to 6. FIG. 2 is a diagram that illustrates the functional configuration of the information processing device in accordance with this embodiment. As illustrated in FIG. 2, the information processing device includes a module data storage 1, a process data storage 2, a parameter data storage 3, an execution instruction storage 4, a process executor 5, a repository 6, a module generator 7, a module storage 8, and a processing process display 9.

The module data storage 1 is configured to store module data of the individual processing modules. The “module data” as used herein refers to data associated with the individual processing modules constituting the processing process. The module data is stored by the user.

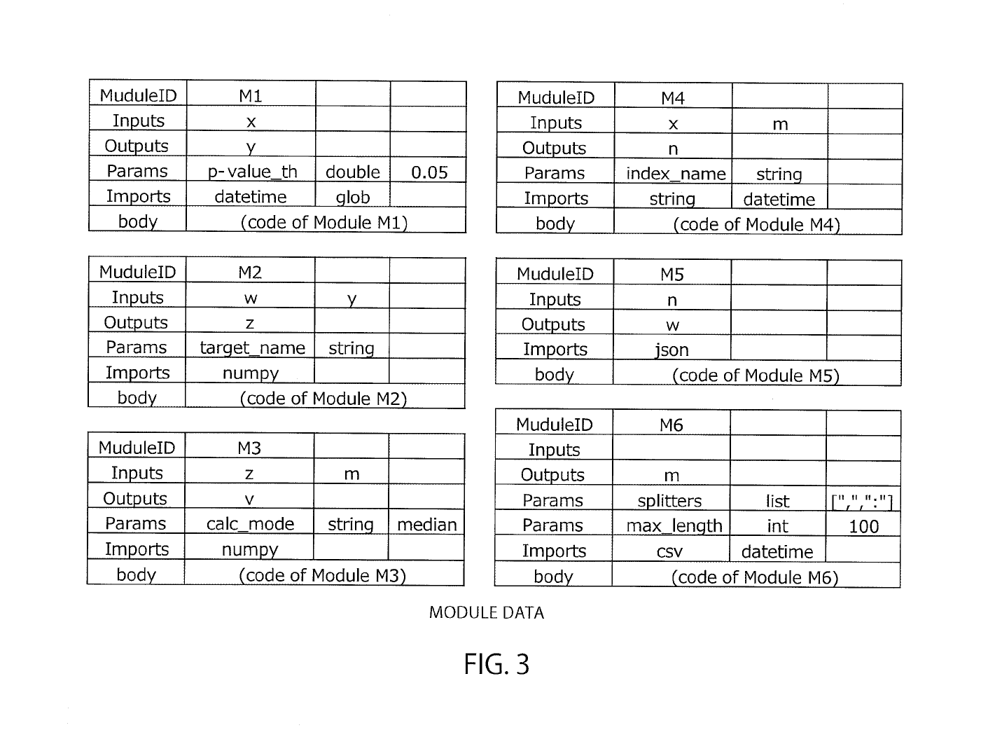

FIG. 3 is a diagram that illustrates an example of the module data stored in the module data storage 1. The module data storage 1 of FIG. 3 corresponds to the processing process of FIG. 1 and configured to store the module data of the processing modules M1 to M6.

In the example of FIG. 3, the module data of the individual processing modules includes a module ID (ModuleID), identifiers (Inputs) of objects input in the processing module (input data), identifiers (Outputs) of objects output from the processing module (output data), identifiers of parameters included in the processing module (Params), setting information of the parameters, external libraries that need to be imported in execution of the processing module (Imports), and program code of the processing module (body). The setting information of the parameter includes data types and set values of the parameters, and the like.

Referring to FIG. 3, for example, an object “x” is input to the processing module 1 as its input data and the processing module 1 outputs an object “y” as its output data. Also, the processing module 1 includes a parameter “p-value_th” and needs to import external libraries “datetime” and “glob” at the time of the execution. The “p-value_th” is a double-type parameter and set to 0.05.

It should be noted that the identifiers of objects such as “x” and “y” appearing in this embodiment are values that are not dependent on the individual processing processes. The user can assign desired data names to the individual identifiers when configuring the processing process. Assignment of the data names will be described later in detail.

The process data storage 2 is configured to store process data of the individual nodes. The “process data” as used herein refers to data that indicates the individual nodes constituting the processing process and the order according to which the individual processing modules are to be executed. The process data is stored by the user.

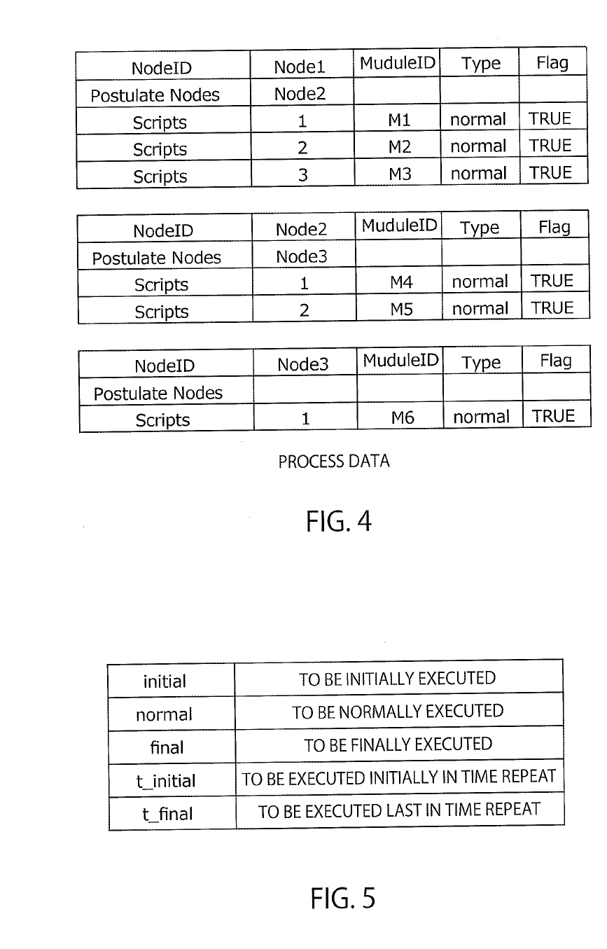

FIG. 4 is a diagram that illustrates an example of the process data stored in the process data storage 2. The process data storage 2 of FIG. 4 corresponds to the processing process of FIG. 1 and stores the process data of the nodes 1 to 3.

In the example of FIG. 4, the process data of the individual nodes includes a node ID (NodeID), an upstream node (Postulate Nodes), and script information (Scripts). The user can specify the order of execution of the nodes by specifying the upstream node with respect to the individual nodes.

The “script information” as used herein refers to information indicative of the sequence of the processes of the processing modules in each node. In the example of FIG. 4, the script information includes the order of execution of the processes, a module ID of the processing module (ModuleID), an execution type of the processing module (Type), and an enable flag of the processing module (Flag).

The “execution type” is an item to be set and indicative of the timing at which the processing module is executed. For example, if the processing processes includes initialization processing, repetitive processing, and end processing, then a processing module X that is only executed in the initialization processing and a processing module Y that is repeatedly executed in repetitive processing may be included in the same node.

In such a case, when the processing modules are executed in accordance with the order specified by the script information, then the processing module Y is executed at the time of the initialization processing and the processing module X is executed at the time of the repetitive processing. As a result, the processing becomes inefficient. For this reason, it is preferable that the specific timings (initialization processing and repetitive processing) of the individual processing modules can be discriminated.

The “execution type” is an item to be set that enables such discrimination. The user who sets the execution types of the individual processing modules is allowed to specify the execution timing of the above-described processing module.

FIG. 5 is a diagram that illustrates an example of the execution types. In FIG. 5, the type “initial” (first type) indicates that this processing module is the first module to be executed among the modules in the entire processing process, in other words, to be executed in the initialization processing. The type “final” (second type) indicates that this processing module is the last module to be executed among the modules of the entire processing process, in other words, to be executed in the end processing.

The type “normal” (third type) indicates that this processing module is ordinarily executed, in other words, executed in accordance with the specified sequence. A processing module whose execution type is set to “normal” is repeatedly executed in accordance with the sequence of processing in repetitive processing.

The type “t_initial” indicates that this processing module is executed at the beginning of a time-repetitive processing. The type “t_final” indicates that this processing module is executed at the end of a time-repetitive processing. The “time-repetitive processing” as used herein refers to processing for calculation of output values in each of a plurality of time periods on the basis of input values that change over time.

The “enable flag” is an item to be set to indicate whether or not the processing module is executed in the execution of the processing process. “TRUE” indicates that the processing module is to be executed and FALSE indicates that the processing module is not to be executed. Switching of the enable flag makes it possible to readily change the processing modules to be executed without changing the configuration of the processing process (nodes included in the processing process, the order of the nodes to be executed, processing modules set in the individual nodes, etc.).

The user who uses the enable flag is allowed to readily perform comparison of results of a where a certain processing module is executed and a case where it is not executed, and perform addition of a processing module for verification. The “processing module for verification” is a processing module for use in verification of whether or not the processing module is appropriately configured. As the processing module for verification, a processing module for exporting intermediate generated data or the like that is not necessary as output data of the processing process or the like may be mentioned.

Referring to FIG. 4, for example, Node 1 has Node 2 as its upstream node (Postulate Node), and has the processing modules M1 to M3 set therefor such that the processing is executed for the processing modules M1, M2, and M3 in this order. Also, the processing modules M1 to M3 are all normally performed and the processing is set to be effective (TRUE).

It should be noted that a plurality of the same processing modules can be set in the process data of the individual nodes. This corresponds, for example, to a case where the third module ID of the node 1 is set as M1. In such a case, the same execution type and the same enable flag may be set to the same processing modules having different positions in the order or different execution types and enable flags may be set thereto.

The parameter storage 3 is configured to store parameter data of the individual nodes. The “parameter data” as used herein refers to data associated with input data, output data, parameters and the like of the processing modules set in the individual nodes constituting the processing process. The parameter data is stored by the user of the information processing device.

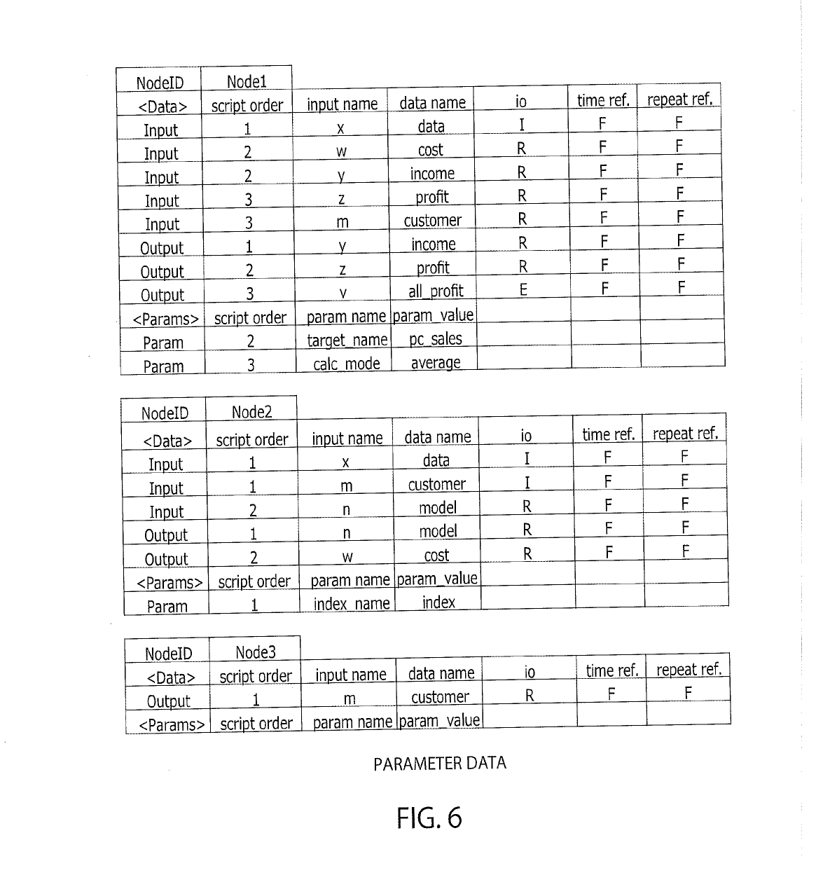

FIG. 6 is a diagram that illustrates an example of the parameter data stored in the parameter data storage 3. The parameter data storage 3 of FIG. 6 corresponds to the processing process of FIG. 1 and stores the parameter data of the nodes 1 to 3.

In the example of FIG. 6, the parameter data of the individual nodes includes setting information regarding input data (Input), setting information regarding output data (Output), and setting information regarding parameters (Param).

The setting information regarding the input data includes the order according to which the processing modules are executed (script order), an identifier of an object input as input data (input name), a data name assigned to the object (data name), an “io” flag (io), a time reference flag (time_ref.), and a repeat reference flag (repeat ref.).

The setting information regarding the output data includes the order according to which the processing modules are executed (script order), an identifier of an object output as output data (input name), a data name assigned to the object (data name), an “io” flag (io), a time reference flag (time_ref.), and a repeat reference flag (repeat ref.).

The setting information regarding the parameters includes the order according to which the processing modules are executed (script order), identifiers of parameters (param name), and parameter names assigned to the parameters (param value).

The data name is a name that can be specified as appropriate by the user to each object having the identifier. The data name is specified such that it is dependent on each processing process. For example, in the example of FIG. 6, a data name labeled as “data” is assigned to the object “x.”

The “io” flag is an item that indicates the settings regarding the import of the input data and the export of the output data. As the “io” flags of the input data, for example, three values I, R, and N are specified.

The value “I” (first input flag) indicates that, when the input data does not exist in the repository and if the import of the input data is possible, then the import is preferentially performed, and if the import is not possible, then a request is made for the upstream node to create the input data.

The value “R” (second input flag) indicates that, when the input data does not exist in the repository, a request is made for the upstream node to create the input data. Specifically, the value R is different than the value I and, even when the input data does not exist in the repository, determination is not made regarding whether or not the import of the input data is possible.

This corresponds to giving a priority to the request for the upstream node to create the input data in preference to (or over) the import of the input data.

The value N (third input flag) indicates that, when the input data does not exist in the repository, the processing is continued on an as-is basis. With regard to the input data whose “io” flag is set to N, it is preferable that an initial value is set as the object data. By virtue of this, when the input data does not exist in the repository, this initial value can be used as the input data.

As the “io” flags of the output data, for example, three values E, D, and R are set.

The value “E” (first output flag) indicates that the output data is exported.

The value “D” (first output flag) indicates that the output data is deleted from the repository after completion of the processing of the node.

The value “R” (first output flag) indicates that the processes corresponding to the values E and D are not carried out. Specifically, the output data whose “io” flag is set to R is not exported or deleted from the repository after the completion of the processing of the node.

The time reference flag indicates whether or not an index of the input data is referred to when the node is subjected to the time-repetitive processing. Also, the repeat reference flag indicates whether or not an index of the input data is referred to when the node is subjected to the repetitive processing. In either case, “T” indicates that the index is referred to and “F” indicates that the index is not referred to. The details of the time reference flag and the repeat reference flag will be described later.

Referring to FIG. 6, for example, “data” (object x) is input to and “income” is output from the first processing module of the node 1. The “data” is imported when it does not exist in the repository or created by the upstream node when it cannot be imported. The “income” is not exported or deleted from the repository after completion of the processing for the node 1.

The user of the information processing device can specify the above-described module data, process data, and parameter data (hereinafter referred to as “module data, etc.”), store them in the module data storage 1, the process data storage 2, and the parameter data storage 3, respectively, and thus configure a desired processing process.

It should be noted that the setting information of the parameters of the individual processing modules may be included in the parameter data. In this case, the setting information of the parameters does not need to be included in the module data.

The execution instruction storage 4 is configured to store the execution instruction input by the user. The execution instruction allows the user to designate the node to be executed. Only one node may be designated or a plurality of the nodes may be designated.

The process executor 5 is configured to execute the processing process in accordance with the execution instruction stored in the execution instruction storage 4.

The repository 6 is configured to store the objects created by the processing process (input data and output data of the individual processing module). The repository 6 stores the objects such that the objects can be referred to by the data names assigned to them.

The module generator 7 refers to the module data storage 1, the process data storage 2, and the parameter storage 3, and generates the execution modules of the individual nodes and the switch modules of the individual nodes.

The “execution module” as used herein refers to a program that executes the processing modules set in the node in accordance with the order of processing specified by the process data. The execution module includes a processing module set in the node. Also, the “switch module” as used herein refers to a program that determines whether or not the individual nodes is executable, and switches the node to be executed in accordance with the result of determination to an upstream node. The processing module and the switch module can be generated by any appropriate programming languages.

The module storage 8 is configured to store the execution module and the switch module generated by the module generator 7.

The processing process display 9 is configured to refer to the module data storage 1, the process data storage 2, and the parameter data storage 3, generate image data for displaying the processing process configured by the user, and output the generated image data on a display device. By virtue of this, an image of the processing process as illustrated in FIG. 1 is displayed on the display device and the processing process is visualized.

The processing process display 9 may refer to the repository 6 and the module storage 8 and cause the information stored in them to be displayed. For example, an object stored in the repository 6 may be displayed.

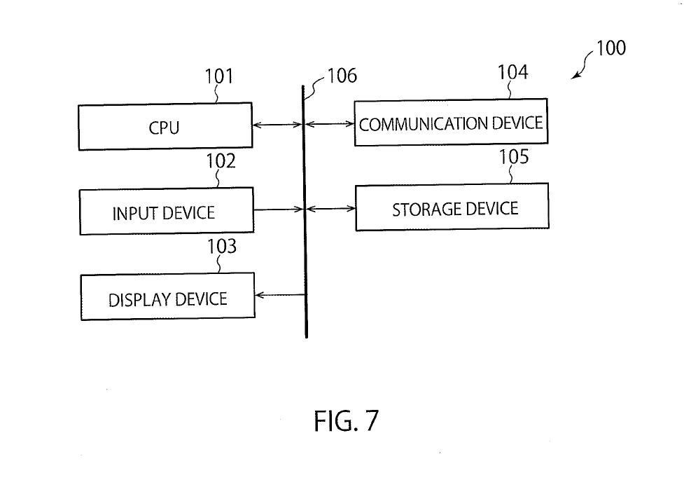

Next, the hardware configuration of the information processing device in accordance with this embodiment is described with reference to FIG. 7. The information processing device in accordance with this embodiment is constituted by the computer 100. The computer 100 includes a server, a client, a microcontroller, a general purpose computer, and the like.

FIG. 7 is a diagram that illustrates an example of the computer 100. As illustrated in FIG. 7, the computer 100 includes a CPU (central processing unit) 101, an input device 102, a display device 103, a communication device 104, and a storage device 105. The CPU 101, the input device 102, the display device 103, the communication device 104, and the storage device 105 are interconnected via a bus 106.

The CPU 101 is an electronic circuit that includes a control device and an arithmetic unit of the computer 100. The CPU 101 carries out arithmetic processing on the basis of data input from the individual device interconnected via the bus 106 (for example, the input device 102, the communication device 104, and the storage device 105) and programs and outputs the results of the arithmetic processing and control signals to the individual devices interconnected via the bus 106 (for example, the display device 103, the communication device 104, and the storage device 105). Specifically, the CPU 101 executes the operating system (OS) and the information processing programs and the like of the computer 100 and controls the individual devices constituting the computer 100.

The information processing program is a program that causes the computer 100 to realize the above-described individual functional features of the information processing device. The information processing program is stored in a non-temporary, tangible, computer-readable storage medium. For example, the above-mentioned storage medium may include, but not limited to, an optical disc, a magneto optical disc, a magnetic disc, a magnetic tape, flash memory, and semiconductor memory. By operation of the information processing program by the CPU 101, the computer 100 functions as the information processing device.

The input device 102 is a device for inputting information in the computer 100. For example, the input device 102 may include, but not limited to, a keyboard, a mouse, and a touch panel. A user is allowed to input information such as the object data, the process data, the parameter data, and the execution instruction by using the input device 102.

The display device 103 is a device for displaying images and videos. For example, the display device 103 may include, but not limited to, an LCD (liquid crystal display), a CRT (cathode-ray tube), and a PDP (plasma display panel). The processing process display 9 can display the generated image data on the display device 103. By virtue of this, the image of the processing process as illustrated in FIG. 1 is displayed on the display device 103.

The communication device 104 is a device for wired or wireless communications by the computer 100 with external devices. For example, the communication device 104 may include, but not limited to, a modem, a hub, and a router. The information such as the object data, the process data, the parameter data, and the execution instruction may be input from the external devices via the communication device 104.

The storage device 105 is a storage medium that stores the operating system (OS) of the computer 100, the information processing program, data necessary for execution of the information processing program, the data generated by the execution of the information processing program, and the like. The storage device 105 includes the main storage device and an external storage device. For example, the main storage device includes, but not limited to, RAM, DRAM, and SRAM. Also, for example, the external storage device includes, but not limited to, a hard disk, optical disc, flash memory, and magnetic tape.

The module data storage 1, the process data storage 2, the parameter data storage 3, the execution instruction storage 4, the repository 6, the module storage 8, storages that store objects and external libraries to be imported, and storages that stores the exported objects may be configured by the storage device 105 or may be configured by an external server or the like that is capable of communications via the communication device 104. In order to accelerate the execution of the processing process, it is preferable that the repository 6 and the module storage 8 are configured by a main storage device.

It should be noted that computer 100 may include one each or a plurality of the CPU 101, the input device 102, the display device 103, the communication device 104, and the storage device 105. And peripheral devices such as a printer and a scanner maybe connected to the computer 100.

Also, the information processing device may be configured by one single computer 100 or may be configured as a system constituted by interconnecting a plurality of the computers 100.

Further, information processing program may be stored in advance in the storage device 105 of the computer 100, stored in a storage medium that is external to the computer 100, or uploaded to the Internet. In any case, the functions of the information processing device are realized by installing the information processing program in the computer 100 and executing the installed information processing program.

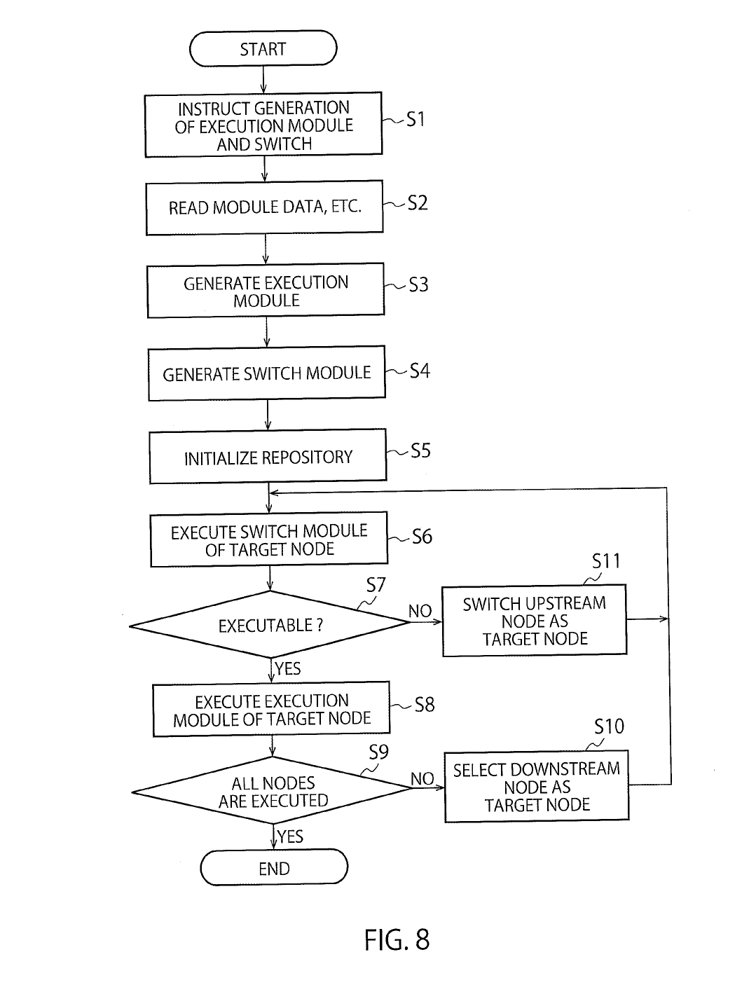

Next, the operation of the information processing device in accordance with this embodiment is described with reference to FIG. 8. FIG. 8 is a flowchart that illustrates an example of operation that takes place when the information processing device in accordance with this embodiment executes the processing process. In the following, it is assumed that the processing process has already been configured. Also, a node executed by the process executor 5 is referred to as “target node.”

When the execution instruction input by the user is stored in the execution instruction storage 4, the process executor 5 reads the stored execution instruction and instructs the module generator 7 to generate the execution module and the switch module (the step S1). Also, the process executor 5 specifies, as the target node, the node designated by the execution instruction that has been read.

When the module generator 7 is instructed by the processor executor 5 to generate the execution module and the switch module, the module generator 7 reads the module data, etc. from the module data storage 1, the process data storage 2, and the parameter data storage 3 (the step S2).

The module generator 7 generates the execution modules of the individual nodes on the basis of the module data, etc. that has been read (the step S3) and stores the generated execution modules in the module storage 8. Specifically, the execution modules of the individual nodes are generated in advance before the execution of the processing process is started.

Also, the module generator 7 generates the switch modules of the individual nodes on the basis of the module data, etc. that has been read (the step S4) and stores the generated switch modules in the module storage 8. Specifically, the switch modules of the individual nodes are generated in advance before the execution of the processing process is started.

It should be noted that the module generator 7 may generate the execution modules of all the nodes included in the processing process in the steps S3 and S4 or may only generate the execution modules of nodes whose execution modules are not stored in the module storage 8. This also applies to the switch modules. Also, the steps S3 and S4 may take place in an inverted order.

When the execution modules and the switch modules of the individual nodes are stored in the module storage 8, the process executor 5 initializes the repository 6 (the step S5).

In addition, the process executor 5 reads the switch module of the target node from the module storage 8, and executes the switch module that has been read (the step S6). By the switch module, whether or not the target node is executable is determined (the step S7).

When it has been determined that the target node is executable (YES in the step S7), the process executor 5 reads the execution module of the target node from the module storage 8 and executes the execution module that has been read (the step S8).

After execution of the target module, the process executor 5 determines whether or not all the nodes designated by the execution instruction have been executed (the step S9). When it has been determined that all the nodes were executed (YES in the step S9), the process executor 5 ends the execution of the processing process. Meanwhile, when any node that is yet to be processed exists (NO in the step S9), the process executor 5 selects the downstream node as a new target node in place of the current target node (the step S10). After that, the processing goes back to the step S6.

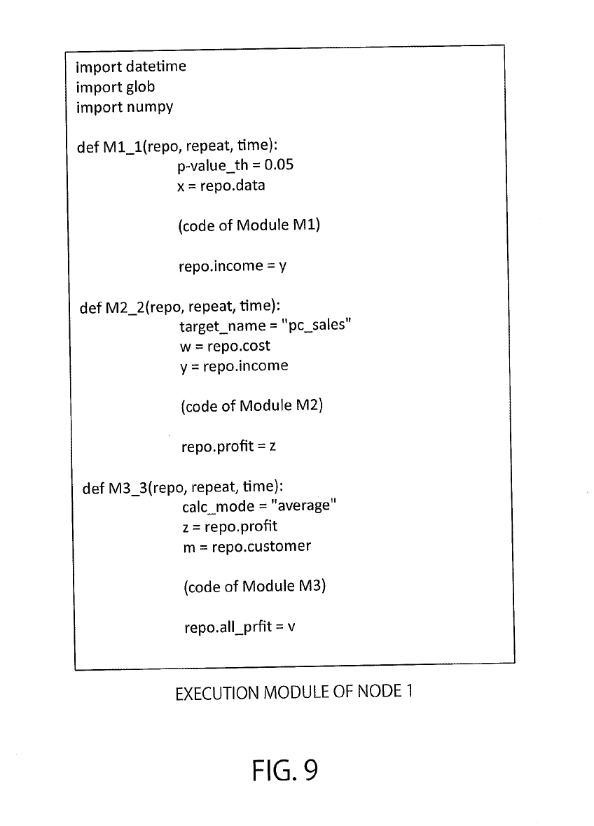

Also, when it has been determined in the step S7 that the target node is not executable (NO in the step S7), the process executor 5 switches the target node to the upstream node (the step S11). After that, the processing goes back to the step S6. Here, the above-described operation of the information processing device is specifically described with reference to FIGS. 9 to 15. In the following, it is assumed that the information processing device executes the processing process of FIG. 1.

When the user inputs the execution instruction, the process executor 5 instructs the module generator 7 to generate the execution module and the switch module (the step S1), the module generator 7 reads the module data, etc. of FIGS. 3, 4, and 6 (the step S2), and generates the execution module and the switch module of the nodes 1 to 3 (the steps S3 and S4).

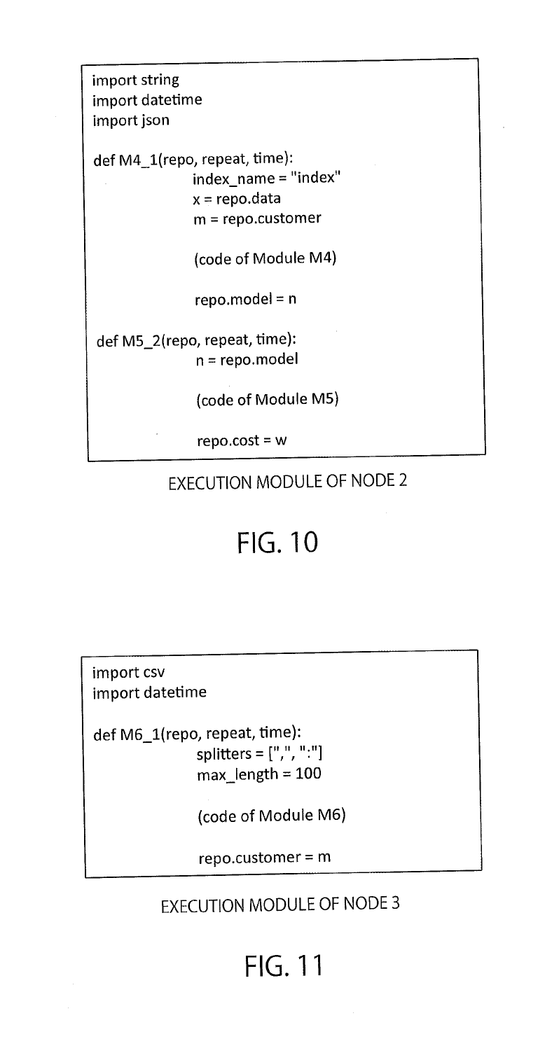

FIG. 9 is a diagram that illustrates an example of the execution module of the node 1. FIG. 10 is a diagram that illustrates an example of the execution module of the node 2. FIG. 11 is a diagram that illustrates an example of the execution module of the node 3. In the examples of FIGS. 9 to 11, the execution module is generated by Python language. In the following, the execution module is described based on the example of the execution module of the node 1 (FIG. 9).

The processing module of the node 1 is constituted by import processing (import) of external libraries which is commonly performed and the processing modules M1 to M3 (def M1_1, def M2_2, and def M3_3) set in the node 1. The processing modules M1 to M3 are arranged in accordance with the order specified in the process data.

The processing module M1 (def M1_1) is constituted by setting of a parameter (p-value_th=0.05), reading of input data from the repository 6 (x=repo.data), execution of a program code (code of Module M1), and writing of output data to the repository 6 (repo.incom=y).

Also, “repo,” “repeat,” and ““time” are set in the processing module M1 as arguments. The “repo” corresponds to reference of the repository 6, the “repeat” corresponds to the repeat information by which the processing module M1 is called, and the “time” corresponds to time information by which the processing module M1 is called.

In the object data, etc., information for generating such an execution module is specified. Accordingly, the module generator 7 can automatically generate the execution modules of the individual nodes on the basis of the object data, etc.

In the execution module of FIG. 9, note that that the parameter value set in the parameter data is given priority when the parameter value set in the module data is different than the parameter value set in the parameter data.

For example, the parameter “calc_mode” of the processing module M3 is set to “median” in the module data and to “average” in the parameter data. As the parameter data is given priority, the parameter “calc_mode” is set to “average” in the processing module M3 of the execution module (calc_mode=“average”).

As can be appreciated from the foregoing, since the set value of the parameter data is given priority over the set value of the module data, it is made possible to change the parameter value without modifying the module data.

Also, when the parameter value is not set in the parameter data, the parameter value set in the module data is used. Specifically, the parameter value set in the module data is used as the default parameter. By virtue of this, it is made possible to reduce the parameter values that need to be set and reduce the workload of the user.

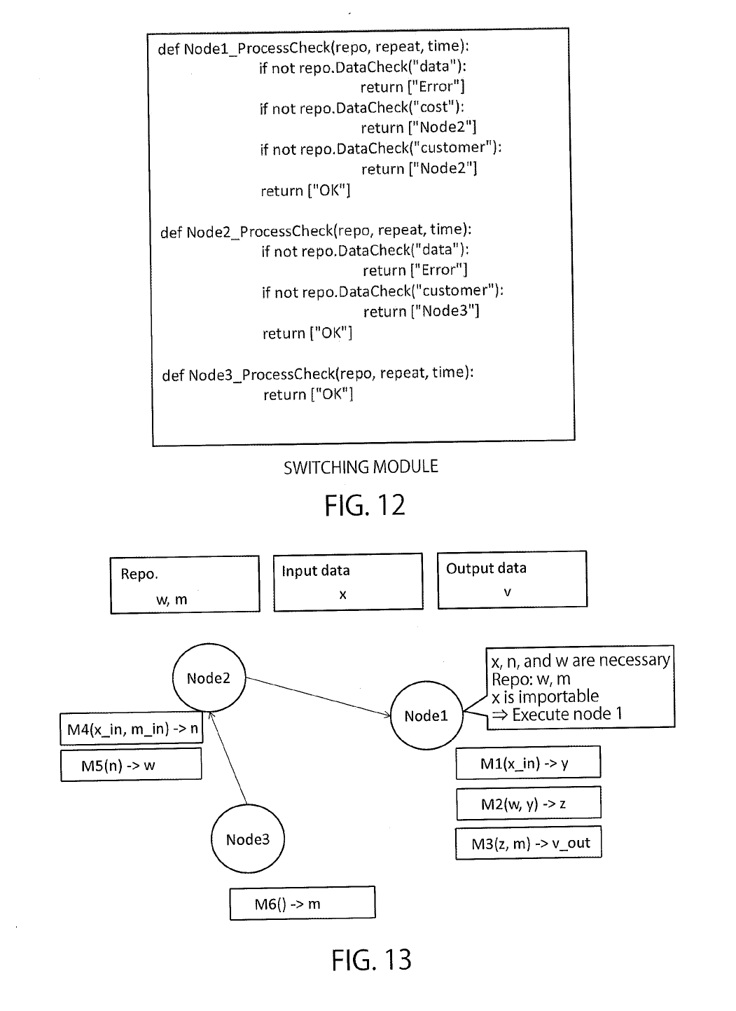

FIG. 12 is a diagram that illustrates an example of the switch module of the nodes 1 to 3. In the example of FIG. 12, the switch module is generated by Python language. As illustrated in FIG. 12, the switch module is constituted by individual switch modules of the nodes, which are arranged such that the most downstream node comes first. In the following, the switch module is described based on the example of the switch module of the node 1.

The switch module of the node 1 (def Node_1ProcessCheck) is a program that determines presence or absence of each input data needed to be input from an external device (repository 6, etc.) to the node 1, and executes the processing in accordance with the result of the determination.

Referring to FIG. 6, the input data of the node 1 includes “data,” “cost,” “income,” “profit,” and “customer” among which the “income” and the “profit” are output by the processing modules 1 and 2, respectively. Accordingly, the input data that needs to be input from an external device to the node 1 will be three pieces, i.e., “data,” “cost,” and “customer.” For this reason, as illustrated in FIG. 12, the switch module of the node 1 is configured as a program that determines whether or not the “data,” the “cost,” and the “customer” exist in an external device.

In the example of FIG. 12, if the above three pieces of input data exist in the repository 6, the switch module of the node 1 returns OK. This corresponds to the determination that the node 1 is executable (YES in the step S7). Subsequently, the process executor 5 executes the execution module of the node 1 (the step S8).

Meanwhile, if the “cost” or the “customer” does not exist in the repository 6, the switch module of the node 1 causes the process to go back to the switch module of the node 2. This corresponds to the fact that the node 1 is determined to be not executable (NO in the step S7) and the upstream node is selected as a new target node (the step S11). Subsequently, switch module of the node 2 is executed.

Also, when the data does not exist in the repository 6, the switch module of the node 1 returns Error. When the Error is returned, the process executor 5 determines whether or not the data can be imported. When the data can be imported, the process executor 5 imports the data and executes the execution module of the node 1 (the step S8). Meanwhile, when the data cannot be imported, the process executor 5 selects the node 2 as a new target node (the step S11). This is because the “io” flag of the data is set to “I” as illustrated in FIG. 6.

In the object data, etc., information for generating such a switch module is set. Accordingly, the module generator 7 can automatically generate the switch modules of the individual nodes on the basis of the object data, etc.

As can be appreciated from the foregoing, execution of the processing process can be accelerated by defining in advance the processing for the case where individual pieces of the input data do not exist.

Here, the specific example of processing by the above-described execution module and switch module is described with reference to FIGS. 13 to 15. In FIGS. 13 to 15, “in” added to the identifier of the object indicates that import takes priority with regard to the object at issue (the “io” flag is set to “I”), and “out” indicates that the object at issue is exported (the “io” flag is set to “E”). This also applies to FIG. 1. Also, it is assumed that the node 1 is designated by the execution instruction as a node to be executed.

In the example of FIG. 13, “w” and “m” are stored in the repository 6 and “x” exists as an importable object. If the target node is the node 1, presence or absence of data (x), cost (w), and customer (m) is determined by the switch module of the node 1. As “w” and “m” exist in the repository 6 and “x” is importable, the node 1 is determined to be executable (YES in the step S7) and execution module of the node 1 is executed (the step S8). As a result, “v” is output by the processing module M3 and the “v” that has been output is exported as output data.

Since execution of all of the designated nodes is completed by the foregoing processing (YES in the step S9), the execution of the processing process is completed.

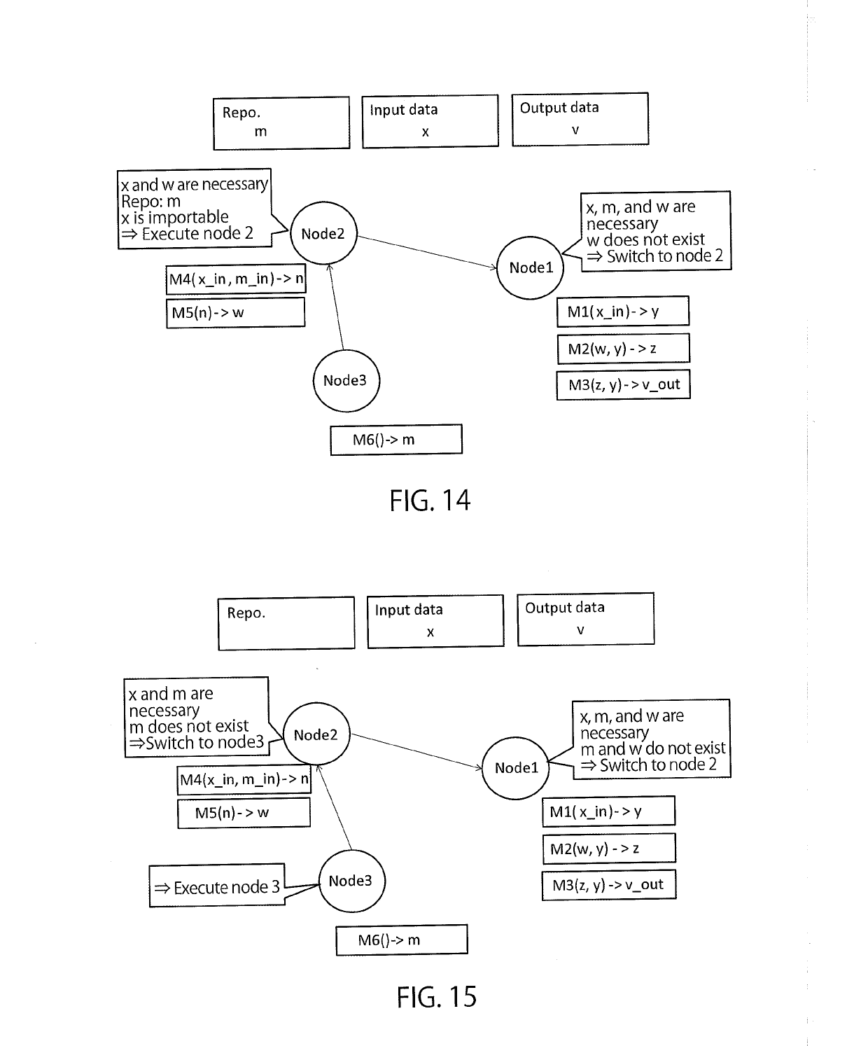

In the example of FIG. 14, “m” is stored in the repository 6, and “x” exists as an importable object. In the example of FIG. 14, which is different from FIG. 13, “w” does not exist in the repository 6, so that the node 1 is determined to be not executable (NO in the step S7). Accordingly, the node 2 is selected as a new target module (the step S11), and the switch module of the node 2 is executed (the step S6).

Subsequently, presence or absence of the data (x) and the customer (m) is determined by the switch module of the node 2. Since the “m” resides in the repository 6 and the “x” is importable, the node 2 is determined to be executable (YES in the step S7), and the execution module of the node 2 is executed (the step S8). As a result, the “w” is output by the processing module M5 and the “w” that has been output is stored in the repository 6.

At this point, since the designated node 1 has not yet been executed (NO in the step S9), the node 1 which is the downstream node is selected as a new target node (the step S10).

Subsequently, when the process executor 5 executes the switch module of the node 1 again (the step S6), the node 1 is determined to be executable because “w” exists in the repository 6 (YES in the step S7). The subsequent processing will proceed in the same manner as in the example of FIG. 13. In the example of FIG. 15, the repository 6 is empty and “x” exists as an importable object. In the example of FIG. 15, “m” and “w” do not exist in the repository 6, so that the node 1 is determined to be not executable (NO in the step S7), the node 2 is selected as a new target module (the step S11), and the switch module of the node 2 is executed (the step S6).

Also, since “m” does not exist in the repository 6, the node 2 is determined to be not executable (NO in the step S7), the node 3 is selected as a new target module (the step S11), and the switch module of the node 3 is executed (the step S6).

Since the switch module of the node 3 returns OK, the execution module of the node 3 is executed (the step S8). As a result, “m” is output by the processing module M6 and the “m” that has been output is stored in the repository 6.

At this point, since the designated node 1 has not yet been executed (NO in the step S9), the target node is switched to the node 2 which is the downstream node (the step S10). The subsequent processing will proceed in the same manner as in the example of FIG. 14.

As described in the foregoing, the information processing device in accordance with this embodiment can set a plurality of processing modules in the individual nodes constituting the processing process. By virtue of this, it is made possible to configure the processing process not by the process-level nodes but by the semantic-level nodes.

When the processing process is reused in another project, the user needs to recognize the correspondence between the original project and the other project (nodes to be modified, method of modifying the nodes, and impacts of a certain node upon other nodes, etc.) and modify the nodes such that the processing process is adapted for the other project.

However, when the processing process is configured by process-level nodes, the individual nodes correspond to the individual processes that are dependent on the original project. As a result, it is difficult for the user to recognize the above-mentioned correspondence.

In contrast, in accordance with this embodiment, when the processing process is configured by semantic-level nodes, the individual nodes are allowed to be adapted for a set of processes whose content can be readily recognized by the user such as a node associated with costs and a node associated with finance. Accordingly, the user can readily recognize the correspondence between the original project and the other project, change the processing process such that it is adapted for the other project, and facilitate reuse of the processing process in the other project.

As can be appreciated from the foregoing, according to the information processing device in accordance with this embodiment, it is made possible to configure a processing process that can be readily reused in other projects. Accordingly, in accordance with this embodiment, it is made possible to reduce the costs related to configuration and management of the processing process, workload of the user, and the like.

Also, in this embodiment, the object name (“x” etc.) input and output by the individual processing modules and the data name (“data” etc.) that depends on the project are separated from each other, and they are associated with each other by the parameter data. Accordingly, the user can use the same processing modules in different projects by modifying the settings of the parameter data.

Further, in this embodiment, it is made possible to generate switch modules by using the input and output data of the individual processing modules explicitly indicated by the parameter data. In addition, use of the switch modules makes it possible to determine whether or not the individual nodes are executable prior to execution thereof and switch the processing to the upstream node if they are not executable. By virtue of this, since nodes that are not executable are not executed, the execution of the processing process can be accelerated.

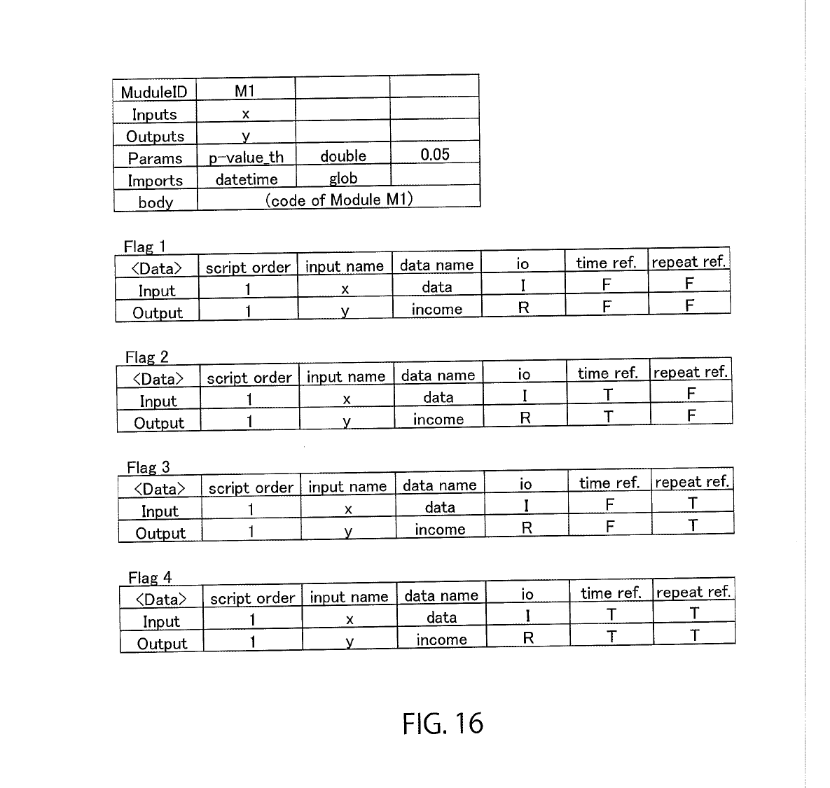

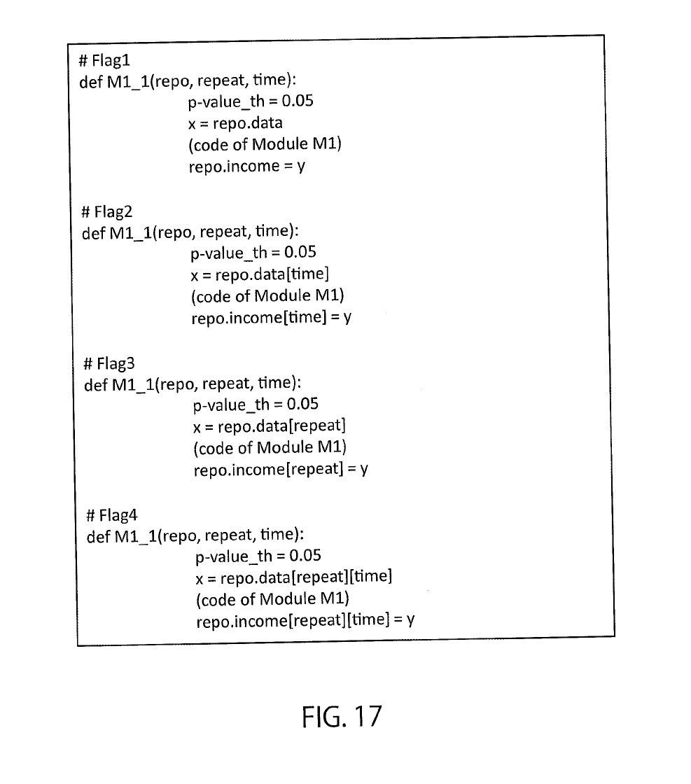

Here, the time reference flag and the repeat reference flag are described with reference to FIG. 16 and FIG. 17. FIG. 16 is a diagram that illustrates an example of the parameter data of the processing module M1. Also, FIG. 17 is a diagram that illustrates an example of the processing module M1 that is adapted for the parameter data of FIG. 16.

As illustrated in FIG. 16, in the example of Flag 1, with regard to “x” and “y,” the time reference flag and the repeat reference flag are both set to “F.” In this case, as illustrated in FIG. 17, in the processing module M1 (#Flag 1, def M1_1), “x” and “y” have the entire “data” and “income” (data, income) referred to, respectively.

As illustrated in FIG. 16, in the example of Flag 2, with regard to “x” and “y,” the time reference flag is set to “T” and the repeat reference flag is set to “F.” In this case, as illustrated in FIG. 17, in the processing module M1 (#Flag 2, def M1_1), “x” and “y” have the portions corresponding to the current time of “data” and “income” (data[time], income[time]) referred to, respectively. Setting of the parameter data of this kind is effective in reusing the processing module M1 in a time-series-based simulation or the like.

As illustrated in FIG. 16, in the example of Flag 3, with regard to “x” and “y,” the time reference flag is set to “F” and the repeat reference flag is set to “T.” In this case, as illustrated in FIG. 17, in the processing module M1 (#Flag 3, def M1_1), “x” and “y” have the portions corresponding to the repeat information of “data” and “income” (the current number of times of repetition, etc.) (data[repeat], income[repeat]) referred to, respectively. Setting of the parameter data of this kind is effective in repeatedly executing the processing module M1.

As illustrated in FIG. 16, in the example of Flag 4, with regard to “x” and “y,” the time reference flag and the repeat reference flag are both set to “T.” In this case, as illustrated in FIG. 17, in the processing module M4 (#Flag 4, def M1_1), “x” and “y” have the portions corresponding to the current time and repeat information of the “data” and “income” (data[repeat][time], income[repeat][time]) referred to, respectively. Setting of the parameter data of this kind is effective in repeatedly executing the processing module M1 in a time-series-based simulation or the like.

It should be noted that the time reference flags of “x” and “y” may be different from each other and the repeat reference flags of “x” and “y” may be different from each other. For example, it is also possible to set the time reference flag of “x” to “F” and the repeat reference flag to “T” while setting the time reference flag of “y” to “T” and the repeat reference flag to “F”.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An information processing device comprising a hardware processor, the hardware processor being configured to,
execute a switch module to determine whether a target node of nodes in a processing process is executable, the processing process being configured by the nodes and connections between the nodes, a plurality of processing modules being capable of being set in the nodes, based at least in part on input data of the processing module which is set in the target node; and
execute the processing module which is set in the target node in response to the target node having been determined to be executable.

2. The information processing device according to claim 1, wherein the switch module determines that the target node is executable when the input data is importable or when the input data is stored in a repository.

3. The information processing device according to claim 1, wherein an upstream node that is upstream with respect to the target node is selected as a new target node when the target node is not executable.

4. The information processing device according to claim 1, wherein an item associated with import is set in the input data of the processing module.

5. The information processing device according to claim 4, wherein the item of the input data is set to any one of a first input flag indicating that import of the input data is preferentially made, a second input flag indicating that priority is given to a request for the upstream node to create the input data in preference to the import, and a third input flag indicating that processing is continued regardless of presence or absence of the input data.

6. The information processing device according to claim 1, wherein an item associated with export is set in an output data of the processing module.

7. The information processing device according to claim 6, wherein the item of the output data is set to any one of a first output flag indicating that the output data is exported, a second output flag indicating that the output data is deleted after completion of processing of the node, and a third output flag indicating that export and deletion of the output data are not performed.

8. The information processing device according to claim 1, wherein the switch module of the target node is generated in advance before execution of the processing process is started.

9. The information processing device according to claim 1, wherein an execution module for execution of the processing module set in the target node is generated in advance before execution of the processing process is started.

10. The information processing device according to claim 1, wherein an execution type indicative of a timing of execution is set in the processing module.

11. The information processing device according to claim 9, wherein the execution type includes at least one of a first type indicating that the execution takes place in initialization processing, a second type indicating that the execution takes place in end processing, and a third type indicating that the execution ordinarily takes place.

12. The information processing device according to claim 1, wherein an enable flag is set in the processing module, the enable flag being indicative of whether or not execution of the processing module takes place in the execution of the processing process.

13. The information processing device according to claim 1, wherein a repeat reference flag is set in the input data of the processing module, the repeat reference flag being indicative of whether or not repeat reference is performed.

14. The information processing device according to claim 1, wherein a time reference flag is set in the input data of the processing module, the time reference flag being indicative of whether or not time reference is performed.

15. The information processing device according to claim 1, wherein a default value is set as a parameter value of the processing module.

16. An information processing method, comprising:
executing a switch module to determine whether a target node of nodes in a processing process is executable, the processing process being configured by the nodes and connections between the nodes, a plurality of processing modules being capable of being set in the nodes, based at least in part on input data of the processing module which is set in the target node; and
executing the processing module which is set in the target node in response to the target node having been determined to be executable.

17. A non-transitory computer readable medium, having a program stored therein which when executed by a computer, causes the computer to perform processing of steps comprising:
executing a switch module to determine whether a target node of nodes in a processing process is executable, the processing process being configured by the nodes and connections between the nodes, a plurality of processing modules being capable of being set in the nodes, based at least in part on input data of the processing module which is set in the target node; and
executing the processing module which is set in the target node in response to the target node having been determined to be executable.
